(19) United States
(12) Patent Application Publication
(10) Pub. No.: US 2020/0277435 A1
(43) Pub. Date: Sep. 3, 2020

(54) DIBLOCK COPOLYMERS AND THEIR USE AS SURFACTANTS

(71) Applicant: Covestro Deutschland AG, Leverkusen (DE)

(72) Inventors: Annika STUTE, Köln (DE); Markus MEURESCH, Köln (DE); Christoph GÜRTLER, Köln (DE); Aurel WOLF, Wülfrath (DE); Reinhard SCHOMÄCKER, Berlin (DE); Michael GRADZIELSKI, Darmstadt (DE); Michelle TUPINAMBA LIMA, Berlin (DE); Vivian SPIERING, Berlin (DE)

(21) Appl. No.: 16/754,198

(22) PCT Filed: Oct. 16, 2018
(86) PCT No.: PCT/EP2018/078186

§ 371 Date: Apr. 7, 2020

(30) Foreign Application Priority Data
Oct. 18, 2017 (EP) 17196961.1
Oct. 10, 2018 (EP) 18199504.4

(51) Int. Cl. C08G 64/18; C08F 297/06; C08G 65/26

(52) U.S. Cl. CPC C08G 64/183; C08G 65/2609; C08G 65/2663; C08F 297/06

(57) ABSTRACT

The present invention relates to the use of diblock copolymers as surfactants, and to a method for producing diblock copolymers, containing a hydrocarbon-containing block A and a polyether carbonate-containing block B, by attaching alkylene oxide and carbon dioxide to H-functional starters in the presence of a double metal cyanide catalyst, characterized in that the H-functional starter has an OH functionality of 1, and the H-functional starter is selected from one or more compounds of the group of monofunctional alcohols having 10 to 20 carbon atoms, and no further catalyst is used in addition to the DMC catalyst.

The present invention relates to a process for the preparation of diblock copolymers, comprising a hydrocarbon-containing block A and a polyethercarbonate-containing block B, by addition of alkylene oxide and carbon dioxide onto an H-functional starter substance in the presence of a double metal cyanide catalyst (DMC catalyst), and also to the use of these diblock copolymers as surfactants.

Processes for the preparation of block copolymers having a low polydispersity index (PDI) are known, for example, from the patent documents WO 00/14045 A1 and EP 2 223 953 A1. The block copolymers are obtained here by the addition of alkylene oxides onto, inter alia, monohydric alcohols in the presence of a DMC catalyst.

WO 2011/117332 A1 describes a method for the preparation of polyethercarbonate polyols from H-functional starter substance, alkylene oxide and carbon dioxide in the presence of a DMC catalyst. The thermal stability of emulsions of the obtained polyethercarbonate polyols or the degradability thereof is not disclosed in the patent document.

DE 27 12 162 A1 describes the preparation of block copolymers using, inter alia, C₈ to C₂₂ alcohols and the incorporation of carbonate units. The document describes that these compounds are surface active and biodegradable. However, the process requires high temperatures and long reaction times.

The object of the present invention is therefore to provide a process which can be carried out without high temperatures, long reaction times and neutralization steps and results in degradable diblock copolymers having high HLB values (hydrophilic-lipophilic balance value) and a low polydispersity index (PDI), wherein no other catalyst is used other than the DMC catalyst. The diblock copolymers shall furthermore be able to be used as surfactants having temperature-independent emulsification characteristics.

It has surprisingly been found that the aforementioned object is achieved by a process for the preparation of diblock copolymers, comprising a hydrocarbon-containing block A and a polyethercarbonate-containing block B, by addition of alkylene oxide and carbon dioxide onto an H-functional starter substance in the presence of a double metal cyanide catalyst, characterized in that the H-functional starter substance has an OH-functionality of 1, and the H-functional starter substance is selected from one or more compounds of the group of monofunctional alcohols having 10 to 20 carbon atoms, and no further catalyst other than the DMC catalyst is used.

In one particular embodiment of the present invention, the diblock copolymers obtained by the inventive process additionally have a lower zero shear rate viscosity.

The OH number (also called the hydroxyl number) in the case of a single added polyol indicates the OH number thereof. Data on the OH number for mixtures relate to the number-average OH number of the mixture, calculated from the OH numbers of the individual components in their respective molar proportions. The OH number indicates the amount of potassium hydroxide in milligrams which is equivalent to the amount of acetic acid bound by one gram of substance during acetylation. It is determined within the context of the present invention according to the standard DIN 53240-1 (June 2013).

Within the context of the present invention, “functionality” refers to the theoretical average functionality (number of isocyanate-reactive or polyol-reactive functions in the molecule) calculated from the known feedstocks and quantitative ratios thereof.

The HLB value describes the ratio between the hydrophilic and lipophilic portions of the diblock copolymer and is determined by comparison with known nonionic surfactants on the basis of the correlation between the phase inversion temperature (PIT) of the diblock copolymer and the HLB value. Here, the PIT is the temperature at which a water-in-oil emulsion becomes an oil-in-water emulsion.

The invention is illustrated in detail hereinafter. Various embodiments can be combined here with one another as desired, unless the opposite is clearly apparent to the person skilled in the art from the context.

The diblock copolymers are prepared by catalytic addition of carbon dioxide and alkylene oxides onto H-functional starter substances. Here, the addition of alkylene oxide and carbon dioxide onto the H-functional starter substance forms block B of the diblock copolymer and consists of a polyethercarbonate-containing radical. The polyethercarbonate-containing block B consists of ether-ether and ether-carbonate structural units, wherein the carbonate groups of the polyethercarbonate-containing block B have a statistical distribution within block B. This reaction is shown schematically in the scheme (I), where R is an organic radical such as alkyl, alkylaryl or aryl, which in each case can also contain heteroatoms such as O, S, Si, etc., and where e, f and g are each an integer, and where the product shown here in scheme (I) for the diblock copolymer should be understood merely as meaning that structural units having the structure shown can in principle be present again in the polyethercarbonate-containing block B obtained, but the order, number and length of the structural units may vary and is not restricted to the diblock copolymer shown in scheme (I). The by-product formed is the cyclic carbonate shown in scheme (I) (by way of example propylene carbonate for R═CH₃, also referred to as cPC hereafter, or ethylene carbonate for R═H, also referred to as cEC hereafter).

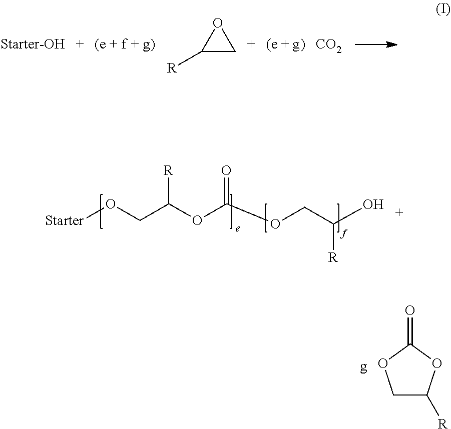

The H-functional starter substance forms, after the addition of alkylene oxide and carbon dioxide, the hydrocarbon-containing block A in the diblock copolymer. Suitable H-functional starter substances used according to the invention are one or more monofunctional alcohols having 10 to 20 carbon atoms. The monofunctional alcohol preferably has 10 to 18 carbon atoms, particularly preferably 10 to 16 and especially 12 to 16 carbon atoms. Examples that may be used include decanol, undecanol, dodecanol, tridecanol, tetradecanol, pentadecanol, hexadecanol, heptadecanol, octadecanol, nonadecanol, eicosanol, 2,2-dimethyl-3-octanol, 9-decen-1-ol, 9-hexadecen-1-ol, 9-octadecen-1-ol, 9,12,15-octadecatrien-1-ol, farnesol, lemonol, citronellol, 2-decyn-1-ol, menthol, cuminic alcohol. Preference is given to using decanol, undecanol, dodecanol, tridecanol, tetradecanol, pentadecanol, hexadecanol, heptadecanol, octadecanol, nonadecanol, eicosanol and particular preference is given to using dodecanol, tridecanol, tetradecanol, hexadecanol and octadecanol. The monofunctional alcohol is preferably aliphatic.

The monofunctional alcohols preferably have a structure of general formula (I)

R¹—OH (I),

wherein R¹ is an alkyl group, alkenyl group or alkynyl group, preferably an alkyl group or alkenyl group and particularly preferably an alkyl group.

Examples of alkyl groups that may be used include decane, undecane, dodecane, tridecane, tetradecane, pentadecane, hexadecane, heptadecane, octadecane, nonadecane, eicosane, 2-propylheptane, 2-butyloctane, 3,3-diethylhexane, 2,2-dimethyloctane. Preference is given to decane, dodecane, tetradecane, hexadecane, octadecane and eicosane, particularly preferably dodecane, tridecane, tetradecane, hexadecane and octadecane.

Examples of alkenyl groups that may be used include decene, undecene, dodecene, tridecene, tetradecene, pentadecene, hexadecene, heptadecene, octadecene, nonadecene, tridecene, eicosene.

Examples of alkynyl groups that may be used include decyne, undecyne, dodecyne, tridecyne, tetradecyne, pentadecyne, hexadecyne, heptadecyne, octadecyne, nonadecyne, tridecene and eicosyne.

The H-functional starter substance can be used individually or as a mixture.

In general, alkylene oxides having 2-45 carbon atoms may be used for the inventive process. Alkylene oxides having 2-45 carbon atoms are by way of example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, singly epoxidized fats in the form of mono-, di- and triglycerides, singly epoxidized fatty acids, C1-C24 esters of singly epoxidized fatty acids, singly epoxidized derivatives of glycidol such as for example methyl glycidyl ether, ethyl glycidyl ether, 2-ethylhexyl glycidyl ether, allyl glycidyl ether, glycidyl methacrylate. The alkylene oxide used is preferably ethylene oxide or a mixture of at least two alkylene oxides containing ethylene oxide, particularly preferably only ethylene oxide is used.

In a preferred embodiment, a mixture of at least two alkylene oxides containing ethylene oxide is used, where the mixture is free of propylene oxide.

The process is preferably characterized in that
(α) the H-functional starter substance or a suspension medium is initially charged and any water and/or other volatile compounds are removed by elevated temperature and/or reduced pressure (“drying”), wherein the DMC catalyst is added to the H-functional starter substance or to the suspension medium before or after the drying,
(β) to achieve activation a portion (based on the total amount of alkylene oxides used in the activation and copolymerization) of alkylene oxide is added to the mixture resulting from step (α), wherein this addition of a portion of alkylene oxide may optionally be effected in the presence of CO₂ and wherein the temperature peak (“hotspot”) which occurs due to the subsequent exothermic chemical reaction and/or a pressure drop in the reactor is then awaited in each case, and wherein step (β) for achieving activation may also be effected repeatedly,
(γ) alkylene oxide, carbon dioxide and optionally H-functional starter substance are added to the mixture resulting from step (β),
wherein at least one H-functional starter substance is added at least in one of steps (α) and (γ).

Step (α):

Preferably, in step (α), the total amount of the H-functional starter substance and also optionally DMC catalyst is initially charged in the reactor. As an alternative, a suspension medium not containing any H-functional groups, and in addition a portion of the H-functional starter substance and also optionally DMC catalyst may also be initially charged in the reactor in step (α), or a portion of the H-functional starter substance and also optionally DMC catalyst may also be initially charged in the reactor in step (α). In addition, it is also possible in step (α) for a suspension medium not containing any H-functional groups to be initially charged in the reactor, optionally together with DMC catalyst, and therefore for no H-functional starter substance to be initially charged in the reactor.

The DMC catalyst is preferably used in an amount such that the content of DMC catalyst with respect to the resulting reaction product is 10 to 10000 ppm, particularly preferably 20 to 5000 ppm and most preferably 50 to 500 ppm.

In a preferred embodiment, inert gas (for example argon or nitrogen), an inert gas/carbon dioxide mixture or carbon dioxide is introduced into the resulting mixture of DMC catalyst with suspension medium and/or H-functional starter substance at a temperature of 90 to 150° C., particularly preferably of 100 to 140° C., and at the same time a reduced pressure (absolute) of 10 mbar to 800 mbar, particularly preferably of 50 mbar to 200 mbar, is applied.

In an alternative preferred embodiment, the resulting mixture of DMC catalyst with suspension medium and/or H-functional starter substance is contacted at a temperature of 90 to 150° C., particularly preferably of 100 to 140° C., at least once, preferably three times, with 1.5 bar to 10 bar (absolute), particularly preferably 3 bar to 6 bar (absolute), of an inert gas (for example argon or nitrogen), an inert gas/carbon dioxide mixture or carbon dioxide and in each case the positive pressure is subsequently reduced to approx. 1 bar (absolute).

The DMC catalyst can be added, for example, in solid form or as a suspension in a suspension medium or a plurality of suspension media or as a suspension in one or more H-functional starter substance(s).

In a further preferred embodiment, in step (α),
(α-I) suspension medium and/or a portion or the total amount of H-functional starter substance is initially charged and
(α-II) the temperature of the suspension medium and/or the H-functional starter substance is brought to 50 to 200° C., preferably 80 to 160° C., particularly preferably 100 to 140° C., and/or the pressure in the reactor is lowered to less than 500 mbar, preferably 5 mbar to 200 mbar, in the course of which an inert gas stream (for example of argon or nitrogen), an inert gas/carbon dioxide stream or a carbon dioxide stream is optionally passed through the reactor,
   wherein the double metal cyanide catalyst is added to the suspension medium and/or to the H-functional starter substance in step (α-I) or immediately thereafter in step (α-II), and
   wherein the suspension medium contains no H-functional groups.

Step (β):

Step (β) serves to activate the DMC catalyst. This step may optionally be performed under an inert gas atmosphere, under an atmosphere composed of inert gas/carbon dioxide mixture or under a carbon dioxide atmosphere. Activation within the meaning of this invention refers to a step in which a portion of alkylene oxide compound is added to the DMC catalyst suspension at temperatures of 90 to 150° C. and the addition of the alkylene oxide compound is then halted, with observation of evolution of heat due to a subsequent exothermic chemical reaction, which can lead to a temperature peak (“hotspot”), and of a pressure drop in the reactor due to the conversion of alkylene oxide and possibly CO₂. The process step of activation is the period from addition of the portion of alkylene oxide compound, optionally in the presence of CO₂, to the DMC catalyst until evolution of heat occurs. Optionally, the portion of alkylene oxide compound can be added to the DMC catalyst in a plurality of individual steps, optionally in the presence of CO₂, and the addition of the alkylene oxide compound can in each case then be halted. In this case the process step of activation comprises the period from addition of the first portion of alkylene oxide compound, optionally in the presence of CO₂, to the DMC catalyst until evolution of heat occurs after addition of the last portion of alkylene oxide compound. In general, the activation step may be preceded by a step for drying the DMC catalyst and optionally the H-functional starter substance at elevated temperature and/or reduced pressure, optionally with passage of an inert gas through the reaction mixture.

The alkylene oxide (and optionally the carbon dioxide) can in principle be metered in in different ways. The metered addition can be started from the reduced pressure or at a preselected supply pressure. The supply pressure is preferably established by introducing an inert gas (for example nitrogen or argon) or carbon dioxide, the (absolute) pressure being 5 mbar to 100 bar, with preference 10 mbar to 70 bar and preferably 20 mbar to 50 bar.

In a preferred embodiment, the amount of one or more alkylene oxides used in the activation in step (β) is 0.1% to 25.0% by weight, preferably 1.0% to 20.0% by weight, particularly preferably 2.0% to 16.0% by weight (based on the amount of suspension medium and/or H-functional starter substance used in step (α)). The alkylene oxide may be added in one step or in two or more portions. Preferably, after addition of a portion of alkylene oxide, the addition of the alkylene oxide is halted until evolution of heat occurs and only then is the next portion of alkylene oxide added. A two-stage activation is also preferred (step β), wherein
(β1) in a first activation stage a first portion of alkylene oxide is added under an inert gas atmosphere and
(β2) in a second activation stage a second portion of alkylene oxide is added under a carbon dioxide atmosphere.

Step (γ):

For the process according to the invention, it has been found that step (γ) is performed advantageously at 50 to 150° C., preferably at 60 to 145° C., particularly preferably at 70 to 140° C. and very particularly preferably at 90 to 130° C. Below 50° C., the reaction to form a diblock copolymer proceeds only very slowly. At temperatures above 150° C., the amount of unwanted by-products rises significantly.

The metered addition of the alkylene oxides and the carbon dioxide can be effected simultaneously, alternately or sequentially, wherein the entire amount of carbon dioxide may be added at once or metered in over the reaction time. It is possible, during the addition of the alkylene oxide, to increase or lower the CO₂ pressure gradually or in steps or to leave it constant. The total pressure is preferably kept constant during the reaction by metered addition of further carbon dioxide. The metered addition of the alkylene oxide and/or of the CO₂ is effected simultaneously, alternately or sequentially with respect to the metered addition of the carbon dioxide. It is possible to meter in the alkylene oxide at a constant metering rate or to increase or lower the metering rate gradually or in steps or to add the alkylene oxide in portions. The alkylene oxide is preferably added to the reaction mixture at a constant metering rate. If a plurality of alkylene oxides are being used for the synthesis of the diblock copolymers, the alkylene oxides may be metered in individually or as a mixture. The metered addition of the alkylene oxides may be effected simultaneously, alternately or sequentially, each via separate metering points (addition points), or via one or more metering points, in which case the alkylene oxides may be metered in individually or as a mixture.

Preferably, an excess of carbon dioxide based on the calculated amount of incorporated carbon dioxide in the diblock copolymer is used since an excess of carbon dioxide is advantageous due to the low reactivity of carbon dioxide. The amount of carbon dioxide may be fixed via the total pressure under the respective reaction conditions. A total pressure (absolute) in the range from 0.01 to 120.00 bar, preferably 0.10 to 110.00 bar, particularly preferably from 1.00 to 100.00 bar has proven to be advantageous for the copolymerization for preparation of the diblock copolymers. It is possible to feed in the carbon dioxide continuously or discontinuously. This depends on how quickly the alkylene oxides and the CO₂ are consumed and on whether the product is to include any CO₂-free polyether blocks or blocks with different CO₂ contents. The amount of the carbon dioxide (reported as pressure) can likewise vary in the course of addition of the alkylene oxides. Depending on the reaction conditions selected, it is possible to introduce the CO₂ into the reactor in the gaseous, liquid or supercritical state. CO₂ may also be added to the reactor as a solid and then be converted under the selected reaction conditions into the gaseous, dissolved, liquid and/or supercritical state.

In a process comprising the metered addition of H-functional starter substance in step (γ), metered addition of H-functional starter substance, of the alkylene oxide and optionally also of the carbon dioxide can be effected simultaneously or sequentially (in portions), by way of example the whole carbon dioxide amount, the amount of H-functional starter substances and/or the amount of alkylene oxides metered in in step (γ) may be added all at once or continuously. The term “continuously” as used here can be defined as a mode of addition of a reactant such that a concentration of the reactant effective for the copolymerization is maintained, meaning that, for example, the metered addition can be effected with a constant metering rate, with a varying metering rate or in portions.

It is possible, during the addition of the alkylene oxide and/or the H-functional starter substance, to increase or lower the CO₂ pressure gradually or in steps or to leave it constant. The total pressure is preferably kept constant during the reaction by metered addition of further carbon dioxide. The metered addition of the alkylene oxide and/or of the H-functional starter substance is effected simultaneously or sequentially with respect to the metered addition of carbon dioxide. It is possible to meter in the alkylene oxide at a constant metering rate or to increase or lower the metering rate gradually or in steps or to add the alkylene oxide in portions. The alkylene oxide is preferably added to the reaction mixture at a constant metering rate. If a plurality of alkylene oxides are being used for the synthesis of the diblock copolymers, the alkylene oxides may be metered in individually or as a mixture. The metered addition of the alkylene oxides and/or of the H-functional starter substances can be effected simultaneously or sequentially, each via separate metering points (addition points), or via one or more metering points, in which case the alkylene oxides and/or the H-functional starter substances can be metered in individually or as a mixture.

In a preferred embodiment, in step (γ), the metered addition of the H-functional starter substance is ended at a juncture prior to the addition of the alkylene oxide.

Preferably, an excess of carbon dioxide based on the calculated amount of incorporated carbon dioxide in the diblock copolymer is used since an excess of carbon dioxide is advantageous due to the low reactivity of carbon dioxide. The amount of carbon dioxide may be fixed via the total pressure under the respective reaction conditions. A total pressure (absolute) in the range from 0.01 to 120.00 bar, preferably 0.10 to 110.00 bar, particularly preferably from 1.00 to 100.00 bar has proven to be advantageous for the copolymerization for preparation of the diblock copolymers. It is possible to feed in the carbon dioxide continuously or discontinuously. This depends on how quickly the alkylene oxides are consumed and on whether block B is supposed to contain any longer polyether units. The amount of the carbon dioxide (reported as pressure) can likewise vary in the course of addition of the alkylene oxides. CO₂ may also be added to the reactor as a solid and then be converted under the selected reaction conditions into the gaseous, dissolved, liquid and/or supercritical state.

One preferred embodiment of the inventive process is characterized, inter alia, in that the total amount of the H-functional starter substance is added in step (γ), that is to say a suspension medium is used in step (α). This addition can be effected at a constant metering rate, with a varying metering rate, or in portions.

Preferably, the diblock copolymers are prepared in a continuous process which comprises both a continuous copolymerization and a continuous addition of the H-functional starter substance. The invention therefore also provides a process wherein, in step (γ), the H-functional starter substance, the alkylene oxide and also the DMC catalyst are continuously metered into the reactor in the presence of carbon dioxide (“copolymerization”) and wherein the resulting reaction mixture (containing the reaction product) is continuously removed from the reactor. Preferably in this case, in step (γ), the DMC catalyst which has been suspended in H-functional starter substance is added continuously. The metered addition of the alkylene oxide, the H-functional starter substance and the DMC catalyst can be effected via separate or combined metering points. In a preferred embodiment, the alkylene oxide and the H-functional starter substance are fed continuously into the reaction mixture via separate metering points. This addition of the H-functional starter substance can be effected in the form of a continuous metered addition to the reactor or in portions.

For example, for the continuous process for preparing the diblock copolymers in steps (α) and (β), an activated DMC catalyst/suspension medium mixture is prepared, then, in step (γ),
(γ1) a portion each of H-functional starter substance, alkylene oxide and carbon dioxide are metered in to initiate the copolymerization, and
(γ2) during the progress of the copolymerization, the remaining amount of each of DMC catalyst, H-functional starter substance and alkylene oxide is metered in continuously in the presence of carbon dioxide, with simultaneous continuous removal of resulting reaction mixture from the reactor.

In step (γ), the DMC catalyst is preferably added suspended in the H-functional starter substance.

Steps (α), (β) and (γ) can be performed in the same reactor, or each can be performed separately in different reactors. Particularly preferred reactor types are: tubular reactors, stirred tanks, loop reactors.

Steps (α), (β) and (γ) can be performed in a stirred tank, in which case the stirred tank, depending on the design and mode of operation, is cooled via the reactor shell, internal cooling surfaces and/or cooling surfaces located within a pumped circulation system. Both in the semi-batchwise process, in which the product is withdrawn only after the reaction has ended, and in the continuous process, in which the product is withdrawn continuously, particular attention should be paid to the metering rate of the alkylene oxide. This should be set such that, in spite of the inhibiting action of the carbon dioxide, the alkylene oxides are depleted by reaction sufficiently quickly.

In a preferred embodiment, the mixture containing activated DMC catalyst that results from steps (α) and (β) is reacted further in the same reactor with alkylene oxide, H-functional starter substance and carbon dioxide. In a further preferred embodiment, the mixture containing activated DMC catalyst that results from steps (α) and (β) is reacted further with alkylene oxide, H-functional starter substance and carbon dioxide in another reaction vessel (for example a stirred tank, tubular reactor or loop reactor).

When conducting the reaction in a tubular reactor, the mixture containing activated DMC catalyst that results from the steps (α) and (β), H-functional starter substance, alkylene oxide and carbon dioxide are pumped continuously through a tube. The molar ratios of the coreactants vary according to the desired polymer. In a preferred embodiment, carbon dioxide is metered in here in its liquid or supercritical form, in order to enable optimal miscibility of the components. Advantageously, mixing elements for better mixing of the coreactants are installed, as sold, for example, by Ehrfeld Mikrotechnik BTS GmbH, or mixer-heat exchanger elements which simultaneously improve the mixing and heat removal.

Loop reactors can likewise be used for performance of steps (α), (β) and (γ). These generally include reactors with recycling of matter, for example a jet loop reactor, which can also be operated continuously, or a tubular reactor designed in the form of a loop with suitable apparatuses for circulation of the reaction mixture, or a loop of a plurality of series-connected tubular reactors. The use of a loop reactor is advantageous especially because backmixing can be achieved here, such that it is possible to keep the concentration of free alkylene oxides in the reaction mixture within the optimal range, preferably in the range from >0% to 40% by weight, particularly preferably >0% to 25% by weight, most preferably >0% to 15% by weight (based in each case on the weight of the reaction mixture).

Preferably, steps (α) and (β) are performed in a first reactor, and the resulting reaction mixture is then transferred into a second reactor for the copolymerization of step (γ). However, it is also possible to perform steps (α), (β) and (γ) in one reactor.

DMC catalysts for use in the homopolymerization of alkylene oxides are known in principle from the prior art (see, for example, U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086, WO 98/16310 and WO 00/47649, have a very high activity and enable the preparation of polyethercarbonate polyols at very low catalyst concentrations. A typical example is that of the highly active DMC catalysts described in EP-A 700 949 which, as well as a double metal cyanide compound (e.g. zinc hexacyanocobaltate(III)) and an organic complex ligand (e.g. tert-butanol), also contain a polyether having a number-average molecular weight greater than 500 g/mol.

The DMC catalysts according to the invention are preferably obtained by
(a) in the first step reacting an aqueous solution of a metal salt with the aqueous solution of a metal cyanide salt in the presence of one or more organic complex ligands, e.g. of an ether or alcohol,
(b) wherein in the second step the solid is separated from the suspension obtained from (a) by means of known techniques (such as centrifugation or filtration),
(c) wherein in a third step the isolated solid is optionally washed with an aqueous solution of an organic complex ligand (for example by resuspension and subsequent reisolation by filtration or centrifugation),
(d) wherein the solid obtained is subsequently dried, optionally after pulverization, at temperatures of generally 20-120° C. and at pressures of generally 0.1 mbar to standard pressure (1013 mbar),
   and wherein, in the first step or immediately after the precipitation of the double metal cyanide compound (second step), one or more organic complex ligands, preferably in excess (based on the double metal cyanide compound), and optionally further complex-forming components are added.

The double metal cyanide compounds present in the DMC catalysts according to the invention are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and then dimethoxyethane (glyme) or tert-butanol (preferably in excess, based on zinc hexacyanocobaltate) is added to the suspension formed.

Metal salts suitable for preparation of the double metal cyanide compounds preferably have the general formula (II)

M(X)ₙ (II)

where

M is selected from the metal cations Zn²⁺, Fe²⁺, Ni²⁺, Mn²⁺, Co²⁺, Sr²⁺, Sn²⁺, Pb₂₊ and Cu²⁺; M is preferably Zn²⁺, Fe²⁺, Co²⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have the general formula (III)

Mᵣ(X)₃ (III)

where

M is selected from the metal cations Fe³⁺, Al³⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have the general formula (IV)

M(X)ₛ (IV)

where

M is selected from the metal cations Mo⁴⁺ and W⁴⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have the general formula (V)

M(X)ₜ (V)

where

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VI)

(Y)ₐM′(CN)_{b}(A)_{c} (VI)

where

M′ is selected from one or more metal cations from the group consisting of Fe(II), Fe(III), Co(II), Co(III), Cr(II), Cr(III), Mn(II), Mn(III), Ir(III), Ni(II), Rh(III) and Ru(II); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca₂₊, Sr₂₊, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and

a, b and c are integers, the values for a, b and c being selected such as to ensure the electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts according to the invention are compounds of the general formula (VII)

Mₓ[M′ₓ,(CN)_{y}]_{z} (VII),

where M is as defined in formula (II) to (V) and

M′ is as defined in formula (VI), and

x, x′, y and z are integers and are selected such as to ensure the electronic neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6 lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). For example, organic complex ligands used are water-soluble organic compounds having heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). Organic complex ligands that are most preferred are selected from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally, in the preparation of the DMC catalysts according to the invention, one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acids or salts, esters or amides thereof, cyclodextrins, phosphorus compounds, α,β-unsaturated carboxylic esters or ionic surface- or interface-active compounds, are used.

Preferably, in the preparation of the DMC catalysts according to the invention, in the first step, the aqueous solutions of the metal salt (e.g. zinc chloride), used in a stoichiometric excess (at least 50 mol %) based on metal cyanide salt, i.e. at least a molar ratio of metal salt to metal cyanide salt of 2.25:1.00, and the metal cyanide salt (e.g. potassium hexacyanocobaltate) are converted in the presence of the organic complex ligand (e.g. tert-butanol), forming a suspension comprising the double metal cyanide compound (e.g. zinc hexacyanocobaltate), water, excess metal salt, and the organic complex ligand.

The organic complex ligand may be present in the aqueous solution of the metal salt and/or the metal cyanide salt, or it is added directly to the suspension obtained after precipitation of the double metal cyanide compound. It has proven to be advantageous to mix the metal salt and metal cyanide salt aqueous solutions and the organic complex ligand with vigorous stirring. Optionally, the suspension formed in the first step is subsequently treated with a further complex-forming component. The complex-forming component is preferably used here in a mixture with water and organic complex ligand. A preferred process for performing the first step (i.e. the preparation of the suspension) is effected using a mixing nozzle, more preferably using a jet disperser as described in WO-A 01/39883.

In the second step, the solid (i.e. the precursor of the inventive catalyst) is isolated from the suspension by known techniques, such as centrifugation or filtration.

In a preferred variant, the isolated solid, in a third process step, is then washed with an aqueous solution of the organic complex ligand (for example by resuspension and subsequent reisolation by filtration or centrifugation). In this way, it is possible to remove, for example, water-soluble by-products such as potassium chloride from the inventive catalyst. Preferably, the amount of the organic complex ligand in the aqueous wash solution is between 40% and 80% by weight, based on the overall solution.

Optionally, in the third step, further complex-forming component is added to the aqueous wash solution, preferably in the range between 0.5% and 5% by weight, based on the overall solution.

It is also advantageous to wash the isolated solid more than once. Preferably, in a first wash step (iii-1), an aqueous solution of the unsaturated alcohol is used for washing (for example by resuspension and subsequent reisolation by filtration or centrifugation), in order in this way to remove, for example, water-soluble by-products such as potassium chloride from the inventive catalyst. The amount of the unsaturated alcohol in the aqueous wash solution is particularly preferably between 40% and 80% by weight, based on the overall solution of the first washing step. In the further wash steps (iii-2), either the first wash step is repeated one or more times, preferably one to three times, or, preferably, a nonaqueous solution, for example a mixture or solution of unsaturated alcohol and further complex-forming component (preferably in the range between 0.5% and 5% by weight, based on the total amount of the wash solution in step (iii-2)), is used as a wash solution, and the solid is washed with it one or more times, preferably one to three times.

The isolated and optionally washed solid is subsequently dried, optionally after pulverization, at temperatures of generally 20-100° C. and at pressures of generally 0.1 mbar to standard pressure (1013 mbar).

A preferred process for isolation of the DMC catalysts according to the invention from the suspension by filtration, filtercake washing and drying is described in WO-A 01/80994.

For the inventive process, no further catalyst other than one or more DMC catalysts is used.

The number-average molecular weight of the diblock copolymers obtained can for example be 200 g/mol to 3000 g/mol, preferably 350 g/mol to 1800 g/mol and particularly preferably 500 to 1500 g/mol. The proportion of incorporated CO₂ (% by weight) in the diblock copolymers, based on the portion of the polymer that was formed under CO₂, can be 1.0% to 30.0% by weight, preferably 1.5% to 20.0% by weight, particularly preferably 2.0% to 10.0% by weight, especially 2.5% to 7.5% by weight.

In a preferred embodiment, a molar ratio of H-functional starter substance to alkylene oxide of 1:1 to 1:30, preferably 1:5 to 1:20 and particularly preferably of 1:8 to 1:18 is used in the inventive process, by means of which a preferred HLB value for the diblock copolymer can be obtained. The diblock copolymers prepared by the inventive process can have an HLB value of at least 6.0, preferably at least 9.0, and particularly preferably at least 11.0.

The polydispersity index of the diblock copolymers obtained can comprise less than 2.00, preferably less than 1.60 and particularly preferably less than 1.30.

The diblock copolymers obtainable by the inventive process have a low PDI with simultaneously high HLB value and as a result are suitable for being used as surfactants in, for example, laundry detergents or dishwashing detergents. The hydrolytic degradability of the inventive diblock copolymers means that they can be readily disposed of in wastewater treatment plants.

In a first embodiment, the invention relates to a process for the preparation of diblock copolymers, comprising a hydrocarbon-containing block A and a polyethercarbonate-containing block B, by addition of alkylene oxide and carbon dioxide onto an H-functional starter substance in the presence of a double metal cyanide catalyst, characterized in that the H-functional starter substance has an OH-functionality of 1, and
the H-functional starter substance is selected from one or more compounds of the group of monofunctional alcohols having 10 to 20 carbon atoms, and
no further catalyst other than the DMC catalyst is used.

In a second embodiment, the invention relates to a process according to the first embodiment, characterized in that the H-functional starter substance is selected from one or more compounds of the group of aliphatic monofunctional alcohols having 10 to 20 carbon atoms.

In a third embodiment, the invention relates to a process according to the first embodiment, characterized in that the H-functional starter substance has a structure of general formula (I)

R¹—OH (I),

wherein

R¹ is a compound selected from the group consisting of alkyl group, alkenyl group or alkynyl group, preferably an alkyl group or alkenyl group, particularly preferably an alkyl group.

In a fourth embodiment, the invention relates to a process according to any of embodiments 1 to 3, characterized in that the H-functional starter substance is selected from one or more compounds of the group of monofunctional alcohols having 10 to 18, preferably 10 to 16, particularly preferably 12 to 16 carbon atoms.

In a fifth embodiment, the invention relates to a process according to any of embodiments 1 to 3, characterized in that the H-functional starter substance(s) is/are selected from one or more compounds of the group comprising decanol, undecanol, dodecanol, tridecanol, tetradecanol, pentadecanol, hexadecanol, heptadecanol, octadecanol, nonadecanol, eicosanol.

In a sixth embodiment, the invention relates to a process according to any of embodiments 1 to 5, characterized in that the alkylene oxide used is ethylene oxide or a mixture of at least two alkylene oxides containing ethylene oxide, particularly preferably only ethylene oxide.

In a seventh embodiment, the invention relates to a process according to embodiment 8, characterized in that the mixture of at least two alkylene oxides containing ethylene oxide is free of propylene oxide.

In an eighth embodiment, the invention relates to a process according to any of embodiments 1 to 7, characterized in that the molar ratio of H-functional starter substance to alkylene oxide is 1.0:1.0 to 1.0:30.0, preferably 1.0:5.0 to 1.0:20.0 and particularly preferably from 1.0:8.0 to 1.0:18.0.

In a ninth embodiment, the invention relates to a process according to any of embodiments 1 to 8, characterized in that
(α) the H-functional starter substance or a suspension medium is initially charged and any water and/or other volatile compounds are removed by elevated temperature and/or reduced pressure (“drying”), wherein the DMC catalyst is added to the H-functional starter substance or to the suspension medium before or after the drying,
(β) to achieve activation a portion (based on the total amount of alkylene oxides used in the activation and copolymerization) of alkylene oxide is added to the mixture resulting from step (α), wherein this addition of a portion of alkylene oxide may optionally be effected in the presence of CO₂ and wherein the temperature peak (“hotspot”) which occurs due to the subsequent exothermic chemical reaction and/or a pressure drop in the reactor is then awaited in each case, and wherein step (β) for achieving activation may also be effected repeatedly,
(γ) alkylene oxide, carbon dioxide and optionally H-functional starter substance are added to the mixture resulting from step (β),
   wherein at least one H-functional starter substance is added at least in one of steps (α) and (γ).

In a tenth embodiment, the invention relates to a process according to any of embodiments 1 to 9, wherein the H-functional starter substance is metered into the reactor continuously during the reaction.

In an eleventh embodiment, the invention relates to the use of a diblock copolymer prepared according to any of embodiments 1 to 10 as a surfactant.

In a twelfth embodiment, the invention relates to diblock copolymers prepared according to any of embodiments 1 to 10.

In a thirteenth embodiment, the invention relates to diblock copolymers according to embodiment 12, characterized in that the diblock copolymers have a polydispersity index of less than 2.0, preferably less than 1.6 and particularly preferably less than 1.3.

In a fourteenth embodiment, the invention relates to diblock copolymers according to either of embodiments 12 and 13, characterized in that the proportion of incorporated CO₂ (% by weight) in the diblock copolymers, based on the portion of the polymer that was formed under CO₂, is 1.0% to 30.0% by weight, preferably 1.5% to 20.0% by weight, particularly preferably 2.0% to 10.0% by weight, especially 2.5% to 7.5% by weight.

In a fifteenth embodiment, the invention relates to diblock copolymers according to any of embodiments 12 to 14, characterized in that the diblock copolymers have a number-average molecular weight of 200 g/mol to 3000 g/mol, preferably 350 g/mol to 1800 g/mol and particularly preferably 500 to 1500 g/mol.

In a sixteenth embodiment, the invention relates to diblock copolymers according to any of embodiments 12 to 16, characterized in that the diblock copolymers have an HLB value (hydrophilic-lipophilic balance value) of at least 6.0, preferably at least 9.0 and especially preferably at least 11.0.

### EXAMPLES

The present invention is elucidated further by the examples which follow, but without being restricted thereto.

### Test Methods

The HLB value of the diblock copolymers is determined by utilizing the correlation between phase inversion temperature (PIT) and HLB value. Here, the PIT is the temperature at which a water-in-oil emulsion becomes an oil-in-water emulsion. The PIT of the diblock copolymers is ascertained by way of measurements of the electrical conductivity as a function of the temperature made on an emulsion of water (47% by weight), octane (47% by weight) and the respective diblock copolymer (6% by weight). The PIT is identifiable by a characteristic drop in the conductivity. Due to the correlation between the PIT and HLB value, the HLB value of the diblock copolymers can be ascertained by means of a comparison with known nonionic surfactants.

The hydrolytic degradability of the inventive diblock copolymers and also of the comparative substances used (cf. table 1: “hydrolytic degradation”) was ascertained at 25° C. and also at 60° C. by the following general method: The degradation of the diblock copolymers was determined by storage of 5% by weight of the diblock copolymer in water at 25° C. and at 60° C. over a period of 30 days. A solution of 2.5 g of the diblock copolymer in 47.5 g of water having a pH of 3, 7 and 11 was prepared in each case for each diblock copolymer. In this case, the pH was adjusted for the pH of 3 by addition of a hydrochloric acid solution having a concentration of 10 mol/l of HCl (Merck Chemicals GmbH), the pH of 7 by addition of an aqueous solution having a concentration of 0.05 mol/l of the buffer phosphate buffer 7.4 (Merck Chemicals GmbH) and for the pH of 11 by addition of a sodium hydroxide solution having a concentration of 3 mol/l of NaOH (Merck Chemicals GmbH). There was a hydrolytic degradability of the diblock copolymers in solution if a reduction of the cloud point by at least 5% and a decrease in the surface tension by at least 10% are observed in the solutions within 30 days. The surface tension is measured here using a DCAT 11 du Noüy ring tensiometer from Dataphysics Instruments GmbH. This measurement involves dipping a platinum ring having a diameter of 18.7 mm into the solution containing the diblock copolymer and withdrawing it again. When withdrawing the ring from this solution, part of the solution is carried along by the ring, which results in an increase in the force expended. The maximum measured force which is required to pull the ring out of the solution containing the diblock polymer is proportional to the surface tension. The cloud point is the temperature from which the solution containing the diblock copolymer separates into two phases and changes from a clear to a cloudy solution. Any observable hydrolytic degradability of the diblock copolymer is identified by an “x” in table 1, where “−” represents a lack of hydrolytic degradation of the diblock copolymer.

In order to determine the temperature dependence of the emulsification characteristics of the diblock copolymers, a mixture of water (47% by weight), octane (47% by weight) and diblock copolymer (6% by weight) is prepared and admixed with butanol. This mixture consists of two phases at 25° C. and on increasing the temperature forms an emulsion as a third phase from the two phases. For this, the sample is heated in a water bath and the temperature range in which the emulsion remains stable is visually assessed. The temperature range thus ascertained is reported in table 1 as “temperature dependence of the emulsification characteristics”.

For the determination of the molar masses, the diblock copolymers are dissolved in methanol (approx. 1 mg/ml) and investigated in an HPLC/MS analysis. The HPLC is characterized by a Grom-Sil-120-OSD-4 HE column and a water/acetonitrile eluent gradient with 0.1% by weight of formic acid in each case. Under these conditions, the homologs of the diblock copolymers elute in a broad peak which is detected by a mass spectrometer (LTQ Orbitrab XL with ESI ionization). This analysis shows a spectrum of molar masses which can be assigned to the individual homologs. The intensity of the peaks is attributed to the frequency of the homologs in the sample and is used for the determination of the number-average molar mass Mₙ (also referred to as molecular weight) and for the calculation of the polydispersity index (PDI).

The mole fraction of the carbonate incorporated in the polymer in the reaction mixture is determined by means of ¹H NMR (Bruker, DPX 400, 400 MHz; pulse program zg30, relaxation delay d1: 10 s, 64 scans) and calculated according to formula (VIII). Each sample was dissolved in deuterated chloroform. The relevant resonances in the ¹H NMR are based on TMS=0 ppm. The following abbreviations are used for formula (VIII):
F(4.5)=area of the resonance at 4.5 ppm for cyclic ethylene carbonate (corresponds to 4 protons).
F(4.3)=area of the resonance at 4.3 ppm for polyethylene glycol carbonate polyol (corresponds to 4 protons).
F(4.2−4.3)=area of the resonance at 4.2−3.3 ppm for polyethylene glycol (corresponds to 4 protons) and two protons for dodecanol/hexadecanol.
F(0.9)=area of the resonance at 0.9 ppm for dodecanol/hexadecanol (corresponds to 3 protons in the terminal methyl group).

Taking account of the relative intensities, the values for the polymer-bound carbonate (“linear carbonate” LC) in the reaction mixture were converted to mol % as per the following formula (VIII):

$$LC = \frac{0.25 * F ( 4.3 )}{\begin{matrix}0.25 * F ( 4.3 ) + [ 0.25 * F ( 4.2 - 3.3 ) - 0.67 * F ( 0.9 ) ] + \\ 0.25 * F ( 4.5 ) + 0.33 * F ( 0.9 )\end{matrix}} * 100 \qquad ( VIII )$$

The proportion by weight (in % by weight) of polymer-bound carbonate (LC′) in the reaction mixture was calculated by formula (IX),

$${LC}^{′} = \frac{0.25 * F ( 4.3 ) * 88}{D} * 100 \% \qquad ( IX )$$

where the value of D (“denominator” D) is calculated by formula (X):

D=0.25*F(4.3)*88+0.25*F(4.5)*88+[0.25*F(4.2−3.3)−0.67*F(0.9)]*44+0.33*F(0.9)*M (X)

The factor of 88 results from the sum of the molar masses of CO₂ (molar mass 44 g/mol) and of ethylene oxide (molar mass 44 g/mol); the factor of 44 results from the molar mass of ethylene oxide. The factor M is 242 for hexadecanol and 186 for dodecanol.

The proportion by weight (in % by weight) of cyclic carbonate (CC′) in the reaction mixture was calculated by formula (XI),

$$C {C}^{′} = \frac{0.2 {5}^{*} F ( 4.5 ) * 88}{D} ⋆ 100 \% \qquad ( XI )$$

where the value of D is calculated by formula (X).

In order to calculate the composition based on the polymer component (consisting of polyether, which was constructed from ethylene oxide during the activation steps taking place under CO₂-free conditions, and diblock copolymer, constructed from starter, ethylene oxide and carbon dioxide during the activation steps taking place in the presence of CO₂ and during the copolymerization) from the values for the composition of the reaction mixture, the non-polymeric constituents of the reaction mixture (that is to say cyclic ethylene carbonate) were mathematically eliminated. The proportion by weight of the carbonate repeating units in the diblock copolymer was converted into a proportion by weight of carbon dioxide by means of the factor F=44/(44+44). The figure for the CO₂ content in the diblock copolymer (“incorporated CO₂”; see examples which follow and table 1) is normalized to the diblock copolymer molecule which has formed in the copolymerization and the activation steps.

Rheological measurements for the determination of the zero shear rate viscosities were carried out using a Bohlin Gemini 200 HR nano rheometer instrument (Malvern Instruments) using the cone geometry. The zero shear rate viscosity was ascertained at 25° C. in an aqueous solution containing 45% to 60% by weight of the measured diblock copolymer. This involved measuring the viscosity as a function of the shear rate in a shear rate range from 0.00014 Hz to 50 Hz. The results of the zero shear rate viscosities are reported in table 2.

### Raw Materials Used

1-Hexadecanol (Sigma-Aldrich)

1-Dodecanol (Sigma-Aldrich)

Ethylene oxide (Linde AG)

Marlipal 24/90—diblock copolymer made from a C₁₂-C₁₄ alcohol mixture and ethylene oxide (Sasol)

Lutensol AT 13—diblock copolymer made from a C₁₆-C₁₈ alcohol mixture and ethylene oxide (BASF SE)

### Example 1: Preparation of a Diblock Copolymer (DBC-1) Using 1-hexadecanol as H-Functional Starter Substance

Step (α):

A 2 liter pressure reactor with gas metering device was initially charged with 200 mg of dried DMC catalyst (prepared according to example 6 of WO-A 01/80994) and 242.40 g of 1-hexadecanol. The suspension was then heated to 130° C. and a constant nitrogen stream and a reduced pressure of 100 mbar were applied for 30 min.

Step (β):

The reactor was subsequently charged with 50 bar of CO₂ at 130° C. and 10 g of ethylene oxide (EO) were metered into the reactor all at once. Activation of the catalyst was perceptible by a temperature peak (“hotspot”) and by a pressure drop to the starting pressure (50 bar). The procedure was repeated once more.

Step (γ):

After activation had occurred, the temperature was adjusted to 100° C. and 586.0 g of ethylene oxide were metered into the reactor within 3 h. The progress of the reaction was monitored via the CO₂ consumption, with the pressure in the reactor being held constant at 50 bar by means of continuously controlled further metered addition. After completion of EO addition, stirring was continued at the pressure indicated above until no further consumption of CO₂ was observed (approximately 1 hour). The product was subsequently removed from the reactor and freed of volatile components on a rotary evaporator.

The diblock copolymer thus prepared features the following properties:

Incorporated CO₂ (% by weight) based on the portion of the polymer that was formed under CO₂: 6.1% by weight;

The selectivity c/l was 1.16 and the polydispersity was 1.02.

### Example 2: Preparation of a Diblock Copolymer (DBC-2) Using 1-dodecanol as H-Functional Starter Substance

Step (α):

A 2 liter pressure reactor with gas metering device was initially charged with 200 mg of dried DMC catalyst (prepared according to example 6 of WO-A 01/80994) and 144.10 g of 1-dodecanol. The suspension was then heated to 130° C. and a constant nitrogen stream and a reduced pressure of 100 mbar were applied for 30 min.

Step (β):

The reactor was subsequently charged with 50 bar of CO₂ at 130° C. and 10 g of ethylene oxide were metered into the reactor all at once. Activation of the catalyst was perceptible by a temperature peak (“hotspot”) and by a pressure drop to the starting pressure (50 bar). The procedure was repeated once more.

Step (γ):

After activation had occurred, the temperature was adjusted to 100° C. and 504.6 g of ethylene oxide were metered into the reactor within 3 h. The progress of the reaction was monitored via the CO₂ consumption, with the pressure in the reactor being held constant at 50 bar by means of continuously controlled further metered addition. After completion of EO addition, stirring was continued at the pressure indicated above until no further consumption of CO₂ was observed (approximately 1 hour). The product was subsequently removed from the reactor and freed of volatile components on a rotary evaporator.

The diblock copolymer thus prepared features the following properties:

Incorporated CO₂ (% by weight) based on the portion of the polymer that was formed under CO₂: 5.0% by weight;

The selectivity al was 1.4 and the polydispersity was 1.03.

### Example 5: Preparation of a Diblock Copolymer (DBC-3) Using 1-dodecanol as H-Functional Starter Substance

Step (α):

A 2 liter pressure reactor with gas metering device was initially charged with 160 mg of dried DMC catalyst (prepared according to example 6 of WO-A 01/80994) and 142.6 g of 1-dodecanol. The suspension was then heated to 130° C. and a constant nitrogen stream and a reduced pressure of 100 mbar were applied for 30 min.

Step (β):

The reactor was subsequently charged with 5 bar of N₂ and 10 g of ethylene oxide were metered into the reactor all at once. Activation of the catalyst was perceptible by a temperature peak (“hotspot”) and by a pressure drop to the starting pressure (5 bar). The reactor was subsequently charged with 20 bar of CO₂.

Step (γ):

After activation had occurred, the temperature was adjusted to 100° C. and 454.6 g of ethylene oxide were metered into the reactor within 4 h. The progress of the reaction was monitored via the CO₂ consumption, with the pressure in the reactor being held constant at 50 bar by means of continuously controlled further metered addition. After completion of EO addition, stirring was continued at the pressure indicated above until no further consumption of CO₂ was observed (approximately 1 hour). The product was subsequently removed from the reactor and freed of volatile components on a rotary evaporator.

The diblock copolymer thus prepared features the following properties:

Incorporated CO₂ (% by weight) based on the portion of the polymer that was formed under CO₂: 2.9% by weight;

The selectivity c/l was 0.86 and the polydispersity was 1.03.

### Example 6: Preparation of a Diblock Copolymer (DBC-4) Using 1-dodecanol as H-Functional Starter Substance

Step (α):

A 2 liter pressure reactor with gas metering device was initially charged with 159 mg of dried DMC catalyst (prepared according to example 6 of WO-A 01/80994) and 144.46 g of 1-dodecanol. The suspension was then heated to 130° C. and a constant nitrogen stream and a reduced pressure of 100 mbar were applied for 30 min.

Step (β):

The reactor was subsequently charged with 50 bar of CO₂ at 130° C. and 10 g of ethylene oxide were metered into the reactor all at once. Activation of the catalyst was perceptible by a temperature peak (“hotspot”) and by a pressure drop to the starting pressure (50 bar). The procedure was repeated once more.

Step (γ):

After activation had occurred, the temperature was adjusted to 100° C. and 454.6 g of ethylene oxide were metered into the reactor within 4 h. The progress of the reaction was monitored via the CO₂ consumption, with the pressure in the reactor being held constant at 50 bar by means of continuously controlled further metered addition. After completion of EO addition, stirring was continued at the pressure indicated above until no further consumption of CO₂ was observed (approximately 1 hour). The product was subsequently removed from the reactor and freed of volatile components on a rotary evaporator.

The diblock copolymer thus prepared features the following properties:

Incorporated CO₂ (% by weight) based on the portion of the polymer that was formed under CO₂: 6.9% by weight;

The selectivity al was 0.79 and the polydispersity was 1.01.

### Example 7: Preparation of a Diblock Copolymer (DBC-5) Using 1-dodecanol as H-Functional Starter Substance

Step (α):

A 2 liter pressure reactor with gas metering device was initially charged with 163 mg of dried DMC catalyst (prepared according to example 6 of WO-A 01/80994) and 144.88 g of 1-dodecanol.

The suspension was then heated to 130° C. and a constant nitrogen stream and a reduced pressure of 100 mbar were applied for 30 min.

Step (β):

The reactor was subsequently charged with 50 bar of CO₂ at 130° C. and 10 g of ethylene oxide were metered into the reactor all at once. Activation of the catalyst was perceptible by a temperature peak (“hotspot”) and by a pressure drop to the starting pressure (50 bar). The procedure was repeated once more.

Step (γ):

After activation had occurred, the temperature was adjusted to 100° C. and 459.6 g of ethylene oxide were metered into the reactor within 9 h. The progress of the reaction was monitored via the CO₂ consumption, with the pressure in the reactor being held constant at 50 bar by means of continuously controlled further metered addition. After completion of EO addition, stirring was continued at the pressure indicated above until no further consumption of CO₂ was observed (approximately 1 hour). The product was subsequently removed from the reactor and freed of volatile components on a rotary evaporator.

The diblock copolymer thus prepared features the following properties:

Incorporated CO₂ (% by weight) based on the portion of the polymer that was formed under CO₂: 8.2% by weight;

The selectivity al was 1.07 and the polydispersity was 1.01.

TABLE 1

| | | Example 1 | Example 2 | Example 3* | Example 4* | Example 5 | Example 6 | Example 7 |
|---|---|---|---|---|---|---|---|---|
| Diblock copolymer | | DBC-1 | DBC-2 | Lutensol AT | Marlipal 24/90 | DBC-3 | DBC-4 | DBC-5 |
| Polydispersity index | | 1.02 | 1.03 | 1.02 | 1.07 | 1.03 | 1.01 | 1.01 |
| Molecular weight Mₙ (g/mol) | | 701 | 750 | 735 | 616 | 792 | 762 | 680 |
| Incorporated CO₂ (% by weight)¹⁾ | | 6.1 | 5.0 | 0 | 0 | 2.9 | 6.9 | 8.2 |
| HLB value | | 12.9 | 15.0 | 12 | 13.4 | 16.5 | 14.9 | 14.3 |
| Hydrolytic | pH 3 | — | — | — | — | — | — | — |
| degradation at | pH 7 | — | — | — | — | — | — | — |
| 25° C. ²⁾ | pH 11 | — | — | — | — | — | — | — |
| Hydrolytic | pH 3 | x | x | — | — | x | x | x |
| degradation at | pH 7 | — | — | — | — | — | — | — |
| 60° C. ²⁾ | pH 11 | x | x | — | — | x | x | x |

| | | | | | | | |
|---|---|---|---|---|---|---|---|
| Cloud point | 60° C. | 88° C. | 77° C. | 82° C. | 76° C. | 80° C. | 69° C. |
| Temperature dependence of the | 32-71° C. | 41-72° C. | 48-71° C. | 49-70° C. | 45-80° C. | 32-72° C. | 45-85° C. |
| emulsification characteristics | | | | | | | |

¹⁾Incorporated CO₂ (% by weight) based on the portion of the polymer that was formed under CO₂.
²⁾ “x”: diblock copolymer is hydrolytically degraded, “—”: diblock copolymer is not hydrolytically degraded.
*Comparative example

The results in table 1 show that the diblock copolymers of the inventive process have a high HLB value and at the same time a low PDI. The diblock copolymers from examples 1 to 7 are stable at room temperature in the ranges of pH 3, 7 and 11 and in the neutral pH range are also stable at 60° C. In contrast to the diblock copolymers from comparative examples 3 and 4, however, the diblock copolymers from inventive examples 1, 2 and 5 to 7 can be degraded at 60° C. by the modification of the pH.

In the case of the diblock copolymer from inventive example 1, there is already formation of the emulsion (third phase) in a temperature range from 32° C. to 71° C. The corresponding diblock copolymer from comparative example 3, which does not comprise any polyethercarbonate-containing block, forms an emulsion in a narrower temperature range from 48° C. to 71° C. The emulsion formed in inventive example 2, with a temperature range from 41° C. to 72° C., is likewise more stable in a broader temperature range than corresponding comparative example 3, with a range from 48° C. to 71° C. The emulsification characteristics of the diblock copolymers obtained with the inventive process are therefore less temperature dependent than in the case of the diblock copolymers from comparative examples 3 and 4. The same applies to the diblock copolymers of examples 5 to 7, which compared to comparative example 4 exhibit a broader temperature range for the formation of the emulsion. The emulsification characteristics of examples 5 to 7 are therefore likewise less temperature dependent than in the case of the diblock copolymer of comparative example 4.

The zero shear rate viscosities measured for examples 2, 4 and 5 to 7 are given in table 2. The inventive examples have significantly lower zero shear rate viscosities in the water/diblock copolymer mixtures than comparative example 4.

TABLE 2

| | Zero shear rate viscosity η₀ in | | | |
|---|---|---|---|---|
| Proportion of | Pa · s for water/diblock copolymer mixtures | | | |
| diblock copolymer | 45% by | 50% by | 55% by | 60% by |
| in the mixture | weight | weight | weight | weight |
| Example 2 | 0.1627 | 0.2711 | 0.3262 | 0.3306 |
| Example 4* | 77 890 | 108 600 | 35 050 | 13 690 |
| Example 5 | 0.2114 | 0.3961 | 0.4537 | 0.5447 |
| Example 6 | 0.1523 | 0.2821 | 0.3094 | 0.4436 |
| Example 7 | 0.3359 | 0.6268 | 0.7371 | 0.7083 |

*Comparative example

1. A process for the preparation of diblock copolymers which comprise, a hydrocarbon-containing block A and a polyethercarbonate-containing block B, comprising adding of alkylene oxide and carbon dioxide onto an H-functional starter substance in the presence of a double metal cyanide catalyst, wherein
the H-functional starter substance has an OH-functionality of 1,
the H-functional starter substance comprises a monofunctional alcohol having 10 to 20 carbon atoms, or a mixture of monofunctional alcohols having 10 to 20 carbon atoms:
and
no additional catalyst other than the DMC catalyst is present.

2. The process as claimed in claim 1, wherein the H-functional starter substance comprises an aliphatic monofunctional alcohol having 10 to 20 carbon atoms, or a mixture of aliphatic monofunctional alcohols having 10 to 20 carbon atoms.

3. The process as claimed in claim 1, wherein the H-functional starter substance has a structure corresponding to the general formula (I)
R¹—OH (I),
wherein
R¹ represents a compound comprising an alkyl group, an alkenyl group or an alkynyl group.

4. The process as claimed in claim 1, wherein the H-functional starter substance comprises a monofunctional alcohol having 10 to 18 carbon atoms, or a mixture of monofunctional alcohols having 10 to 18 carbon atoms.

5. The process as claimed in claim 1, wherein the H-functional starter substance comprises a of decanol, undecanol, dodecanol, tridecanol, tetradecanol, pentadecanol, hexadecanol, heptadecanol, octadecanol, nonadecanol, eicosanol, or mixtures thereof.

6. The process as claimed in claim 1, wherein the alkylene oxide comprises ethylene oxide or a mixture of at least two alkylene oxides containing ethylene oxide.

7. The process as claimed in claim 6, wherein the mixture of at least two alkylene oxides containing ethylene oxide is free of propylene oxide.

8. The process as claimed in any of claim 1, wherein the molar ratio of H-functional starter substance to alkylene oxide is 1.0:1.0 to 1.0:30.0.

9. The process as claimed in claim 1, comprising
(α) initially charging the H-functional starter substance or a suspension medium and removing any water and/or other volatile compounds by elevated temperature and/or reduced pressure (“drying”), wherein the DMC catalyst is added to the H-functional starter substance or to the suspension medium before or after the drying,
(β) adding a portion (based on the total amount of alkylene oxides used in the activation and copolymerization) of alkylene oxide to the mixture resulting from step (α) to achieve activation, wherein this addition of a portion of alkylene oxide may optionally be effected in the presence of CO₂ and wherein the temperature peak (“hotspot”) which occurs due to the subsequent exothermic chemical reaction and/or a pressure drop in the reactor is then awaited in each case, and wherein step (β) for achieving activation may also be effected repeatedly,
(γ) adding alkylene oxide, carbon dioxide and optionally H-functional starter substance to the mixture resulting from step (β),
wherein at least one H-functional starter substance is added at least in one of steps (α) and (γ).

10. The process as claimed in claim 1, wherein the H-functional starter substance is metered into the reactor continuously during the reaction.

11. A surfactant comprising the diblock copolymer prepared by a process as claimed in claim 1.

12. Diblock copolymers comprising the reaction product of an alkylene oxide and carbon dioxide onto a H-functional starter substance in the presence of a double metal cyanide catalyst, wherein the H-functional starter substance has a hydroxyl functionality of 1, and comprises a monofunctional alcohol having 10 to 20 carbon atoms or a mixture of monofunctional alcohols having 10 to 20 carbon atoms; and no additional catalysts other than the double metal cyanide catalyst are present.

13. Diblock copolymers as claimed in claim 12, wherein the diblock copolymers have a polydispersity index of less than 2.00.

14. Diblock copolymers as claimed in claim 12, wherein the proportion of incorporated CO₂ (% by weight) in the diblock copolymers, based on the portion of the polymer that was formed under CO₂, is 1.0% to 30.0% by weight.

15. Diblock copolymers as claimed in claim 12, wherein the diblock copolymers have a number-average molecular weight of 200 g/mol to 3000 g/mol.
